(19) United States
(12) Patent Application Publication
(10) Pub. No.: US 2025/0224540 A1
(43) Pub. Date: Jul. 10, 2025

(54) FLOOD FORECASTING SYSTEM DRIVEN BY MULTI-SOURCE FUSION PRECIPITATION INFORMATION AND REAL-TIME PERCEPTION INFORMATION

(71) Applicant: NANJING HYDRAULIC RESEARCH INSTITUTE, Nanjing (CN)

(72) Inventors: Tiesheng Guan, Nanjing (CN); Meng Yang, Nanjing (CN); Junliang Jin, Nanjing (CN); Yanli Liu, Nanjing (CN); Xin Yin, Nanjing (CN); Haibin Zhang, Nanjing (CN); Qin Xu, Nanjing (CN); Yufei Ma, Nanjing (CN); Senlin Li, Nanjing (CN); Longhai Feng, Nanjing (CN); Xinbo Cui, Nanjing (CN); Feng Wang, Nanjing (CN)

(73) Assignee: NANJING HYDRAULIC RESEARCH INSTITUTE, Nanjing (CN)

(21) Appl. No.: 18/637,540

(22) Filed: Apr. 17, 2024

(30) Foreign Application Priority Data
Jan. 8, 2024 (CN) 202410021852.2

(51) Int. Cl. G01W 1/10; G01W 1/14; G01W 1/18

(52) U.S. Cl. CPC G01W 1/10; G01W 1/14; G01W 1/18; G01W 2203/00

(57) ABSTRACT

Disclosed is a flood forecasting system driven by multi-source fusion precipitation information and real-time perception information, which comprises a flood multi-information embedding platform, the flood multi-information embedding platform is fixed in a river channel via a fixing device, the flood multi-information embedding platform is provided with a plurality of large-flow through holes and a plurality of small-flow through holes which are symmetrically distributed left and right, a large sleeve is mounted on the large-flow through hole, a small sleeve is mounted on the small-flow through hole, a rotatable rotation blade is fixedly mounted in the large sleeve, the flood multi-information embedding platform is further provided with a blind hole, and a cylinder is mounted in the blind hole.

### CROSS-REFERENCE TO RELATED APPLICATIONS

This application claims priority to Chinese Patent Application Ser. No. CN202410021852.2 filed on 8 Jan. 2024.

### TECHNICAL FIELD

The present invention relates to a flood forecasting system driven by multi-source fusion precipitation information and real-time perception information and a method thereof, and belongs to the field of flood forecasting in water conservancy projects.

### BACKGROUND

Flood is one of the common natural disasters in human history. Under the background of the intensification of global climate change and the increasing influence of human activities, the frequency and scale of flood have been on the increase in recent years, which has brought profound disasters to people all over the world. In the first three quarters of 2023, there were 35 regional rainstorm processes in China. From the end of July to the beginning of August, extreme rainstorm weather occurred in North China and Northeast China in succession, a basin-wide catastrophic flood occurred in Haihe River Basin, a numbered flood occurred in Songhua River, some areas suffered from “sharp conversion between drought and flood”, many flood storage and detention areas in Beijing, Tianjin and Hebei were put into service, and some farmlands were flooded and infrastructures were seriously damaged in Heilongjiang and Jilin.

The flood not only affects residents in affected areas, but also may affect the economic, social and ecological environments of the whole country and even the whole world. The flood may lead to problems such as food shortage, rising prices and the spread of diseases, thus bringing a great pressure to people's lives. There are more than 50,000 small and medium-sized rivers in China (with a basin area of over 100 km²), which are widely distributed and have complex geographical conditions. Early warning and forecasting of flood is an important non-engineering measure to take timely flood prevention emergency measures to minimize flood losses. For a long time, scholars at home and abroad have mainly paid attention to the flood control work of rivers, which has made a great progress in construction of flood control engineering facilities and flood monitoring and forecasting system for large rivers, but a large number of widely distributed small and medium-sized rivers still have the disaster problem that “heavy rain causes a great disaster and light rain causes a small disaster”.

Especially in areas without data, the flood data cannot be collected and transmitted in time, which affects the timeliness and accuracy of flood forecasting. Meanwhile, relevant technical standards have not been formed for the flood forecasting of small and medium-sized rivers, it is difficult to guarantee the accuracy and timeliness of relevant schemes. The flood occurring in small and medium-sized river basins is seasonal, and the temporary flood in flood season converges quickly, causes a disaster quickly, and has strong destructiveness. Due to the lack of hydrological data, and the lack and incompletion of historical flood data in small and medium-sized river basins, how to improve the accuracy of flood forecasting and prolong a forecast period of flood forecasting is a key problem to be solved urgently for the flood forecasting of the small and medium-sized river basins.

In order to realize the dynamic perception and forecasting of multi-regional and multi-duration floods, a perception and forecasting system needs to have real-time online and multi-scale characteristics. Based on the latest technology, related theoretical researches of the flood perception and forecasting system are obviously insufficient, and it is urgent to develop a system and complete technology capable of realizing effective perception and forecasting.

### SUMMARY

Object of the present invention: in order to overcome the defects in the prior art, the present invention provides a flood forecasting system driven by multi-source fusion precipitation information and real-time perception information and a method thereof, and the system greatly improves the accuracy and efficiency of flood forecasting, has almost no requirement on the surrounding environment, has very strong applicability, and perfectly meets the requirement of the current flood forecasting field especially in the face of the problem of flood forecasting in areas without data.

Technical solution: in order to solve the above technical problem, a flood forecasting system driven by multi-source fusion precipitation information and real-time perception information of the present invention comprises a flood multi-information embedding platform, wherein the flood multi-information embedding platform is fixed in a river channel via a fixing device, the flood multi-information embedding platform is provided with a plurality of large-flow through holes and a plurality of small-flow through holes which are symmetrically distributed left and right, a large sleeve is mounted on the large-flow through hole, a small sleeve is mounted on the small-flow through hole, a rotatable rotation blade is fixedly mounted in the large sleeve, the flood multi-information embedding platform is further provided with a blind hole, and a cylinder is mounted in the blind hole; and a left end surface calibration control end and a right end surface calibration control end are respectively mounted on two sides of a top end of the flood multi-information embedding platform, a middle portion of a top portion of the flood multi-information embedding platform is provided with a far-end information carrying box, and an optical fiber sequentially penetrates through the plurality of large-flow through holes, the plurality of small-flow through holes and the cylinder via the left end surface calibration control end, and is led out via the right end surface calibration control end.

Preferably, a plurality of wedge blocks are mounted on the flood multi-information embedding platform, the wedge block is provided with a through hole, and the optical fiber penetrates via the through hole.

Preferably, the wedge block is mounted on the flood multi-information embedding platform via a fastener.

Preferably, the large sleeve is provided with an external thread, a large elastic block is sleeved on the large sleeve, the optical fiber is pressed on the large sleeve via the large elastic block, and the large elastic block is fixed on the large sleeve via a nut.

Preferably, the small sleeve is provided with an external thread, a small elastic block is sleeved on the small sleeve, the optical fiber is pressed on the small sleeve via the small elastic block, and the small elastic block is fixed on the small sleeve via a nut.

Preferably, the cylinder is provided with an arc-shaped groove, and the optical fiber penetrates through the arc-shaped groove and is fixed in the arc-shaped groove via a pressing block.

Preferably, the optical fiber located in the lower-left large-flow through hole of the flood multi-information embedding platform is wound on the large sleeve by 360°.

Preferably, the rotation blades are distributed in lower left, middle and lower right areas of the flood multi-information embedding platform, and in the middle portion of the flood multi-information embedding platform, at least a part of the rotation blades are distributed in upper, middle and lower portions of the flood multi-information embedding platform.

Preferably, inner walls of the large sleeve and the small sleeve are both polished.

A use method of the flood forecasting system driven by multi-source fusion precipitation information and real-time perception information above comprises the following steps of:
firstly, sequentially arranging and connecting a left end surface outlet optical fiber, a left end surface optical fiber, thane optical fiber located in a middle portion of a flood multi-information embedding platform, a right end surface optical fiber and a right end surface outlet optical fiber, wherein the left end surface outlet optical fiber, the left end surface optical fiber, the optical fiber connected in the middle, the right end surface optical fiber and the right end surface outlet optical fiber are an integral optical fiber, the left end surface outlet optical fiber penetrates through two sides of a left end surface calibration control end, a joint between the left end surface outlet optical fiber and the left end surface calibration control end is flexibly fixed, a joint between the right end surface outlet optical fiber and a right end surface calibration control end is flexibly fixed, the left end surface optical fiber is arranged along a small-flow through hole, circumferentially wound around a lower-left large-flow through hole, and then connected to an upper-middle large-flow through hole, and then passes through the small-flow through hole to be circumferentially connected to a cylinder, a sensing optical fiber is connected to the small-flow through hole via the nut, and the sensing optical fiber is connected to the small-flow through hole, the lower-left large-flow through hole, the upper-middle large-flow through hole and a lower-right large-flow through hole via wedge blocks;
secondly, performing initial sensing and calibration on the left end surface outlet optical fiber, the left end surface optical fiber, the optical fiber connected in the middle, the right end surface optical fiber and the right end surface outlet optical fiber, performing strain calibration on the distributed sensing optical fiber in the left end surface calibration control end, and performing vibration calibration on the point sensing optical fiber in the right end surface calibration control end;
thirdly, rotating the rotation blades in the lower-left large-flow through hole, the upper-middle large-flow through hole and the lower-right large-flow through hole to test that the rotation blades run normally, and testing data information of the sensing optical fiber under rotating and non-rotating states of the rotation blades;
fourthly, determining a quantity of flood multi-information embedding platforms, effectively connecting a plurality of flood multi-information embedding platforms via a connecting device, and effectively connecting the left end surface outlet optical fiber and the right end surface outlet optical fiber with the right end surface outlet optical fiber and the left end surface outlet optical fiber on other flood multi-information embedding platforms; and
fifthly, arranging the plurality of flood multi-information embedding platforms in a flood area to be tested for real-time sensing, receiving information of atmospheric movement and precipitation in the area collected from satellites and ground by a far-end information carrying box, and fusing, transmitting and forecasting information of the sensing fiber by the far-end information carrying box.

In the present invention, the left end surface outlet optical fiber is sequentially connected with the left end surface optical fiber, the optical fiber connected in the middle, the right end surface optical fiber and the right end surface outlet optical fiber to form a distributed flood sensing network of complete and segmented perception and calibration. The distributed sensing optical fiber without external interference is arranged in the left end surface calibration control end, and the left end surface calibration control end is in direct contact with the outside, so that the flood cannot be in contact with the distributed sensing optical fiber in the left end surface calibration control end, and the point sensing optical fiber without external interference is arranged in the right end surface calibration control end, and the right end surface calibration control end is in direct contact with the outside, so that the flood cannot be in contact with the point sensing optical fiber in the right end surface calibration control end. The flood multi-information embedding platform comprises five wedge blocks, which are distributed in middle positions of the small-flow through hole, the lower-left large-flow through hole, the upper-middle large-flow through hole and the lower-right large-flow through hole, and wide openings of the wedges are upward and narrow openings of the wedges are downward. The wedge blocks are mainly used for fixation in spatial position and sensing and calibration around the lower-left large-flow through hole, the upper-middle large-flow through hole and the lower-right large-flow through hole. The rotation blades are arranged in the lower-left large-flow through hole, the upper-middle large-flow through hole and the lower-right large-flow through hole, the rotation blades may record an impact of an overflow flood, and an intensity of the overflow flood is analyzed by recording numbers of rotations of the rotation blades, which is mutually corrected with a sensing result of the sensing optical fiber. The lower-left large-flow through hole and the lower-right large-flow through hole are distributed on left and right sides of the flood multi-information embedding platform, and the lower-left large-flow through hole and the lower-right large-flow through hole maintain symmetry in spatial position, so as to ensure symmetrical impacts of overflow floods on left and right sides on the flood multi-information embedding platform. An inner side of the small-flow through hole is polished to form a low-resistance through hole, so as to ensure that the overflow flood passes through without resistance herein, and the sensing optical fiber respectively passes through outer edges of small-flow through holes located in an upper portion, a middle portion, a lower portion, a left side area, a middle area and a right side area of the flood multi-information embedding platform in the left side area, the middle area and the right side area, and is connected to the small-flow through holes via the small elastic blocks. The left end surface optical fiber is wound around the lower-left large-flow through hole by 360°, the optical fiber connected in the middle is tightly attached to the upper-middle large-flow through hole in the middle area to be fixed and calibrated via the wedge blocks on two sides, and the right end surface optical fiber is tightly attached to the cylinder to be wound and fixed. In the case that the lower-left large-flow through hole and the lower-right large-flow through hole are completely symmetrical, the flood impact on the cylinder is monitored, and then a flood grade is analyzed from a perspective of load effect.

In the present invention, the rotation blades are mainly distributed in the left side area, the middle area and the right side area of the flood multi-information embedding platform, and in the middle area, the rotation blade is further provided with an upper portion, a middle portion and a lower portion, so as to comprehensively grasp information from the flood borne by the flood multi-information embedding platform.

Beneficial effects: the flood forecasting system driven by multi-source fusion precipitation information and real-time perception information of the present invention has a complete structure, can realize flow and automatic application, and has great advantages in reducing a sensing and forecasting cost, improving sensing and forecasting accuracy, improving engineering practicability, and the like; and the flood forecasting system driven by multi-source fusion precipitation information and real-time perception information of the present invention comprises the plurality of flood multi-information embedding platforms, the flood multi-information embedding platform further comprises core assemblies such as the left end surface calibration control end, the far-end information carrying box, the right end surface calibration control end, the small-flow through hole, the lower-left large-flow through hole, the upper-middle large-flow through hole, the lower-right large-flow through hole and the wedge block, and then a combined mode of different partition perception, different mode contrast perception, far-end information fusion perception, distributed perception and the like is realized, so that the flood forecasting system driven by multi-source fusion precipitation information and real-time perception information is developed. The present invention greatly improves the accuracy and efficiency of flood forecasting, has almost no requirement on the surrounding environment, has very strong applicability, and perfectly meets the requirement of the current flood forecasting field especially in the face of the problem of flood forecasting in areas without data, thus greatly expanding a range of sensing and forecasting, and greatly improving an application and popularization ability of this technology in practical engineering.

### BRIEF DESCRIPTION OF THE DRAWINGS

FIG. 1 is a schematic structural diagram of the present invention.

FIG. 2 is a schematic structural diagram of a large sleeve.

In the drawings, 01 refers to left end surface outlet optical fiber; 02 refers to left end surface calibration control end; 03 refers to small-flow through hole; 04 refers to left closed connecting rod; 05 refers to left end surface optical fiber; 06 refers to lower-left large-flow through hole; 07 refers to far-end information carrying box; 08 refers to upper-middle large-flow through hole; 09 refers to optical fiber connected in the middle; 10 refers to wedge block; 12 refers to right end surface calibration control end; 13 refers to right end surface outlet optical fiber; 14 refers to right closed connecting rod; 15 refers to cylinder; 16 refers to lower-right large-flow through hole; 17 refers to right end surface optical fiber; 18 refers to rotation blade; 20 refers to flood multi-information embedding platform; 21 refers to large sleeve; 22 refers to nut; and 23 refers to large elastic block.

### DETAILED DESCRIPTION

The present invention is further described hereinafter with reference to the drawings.

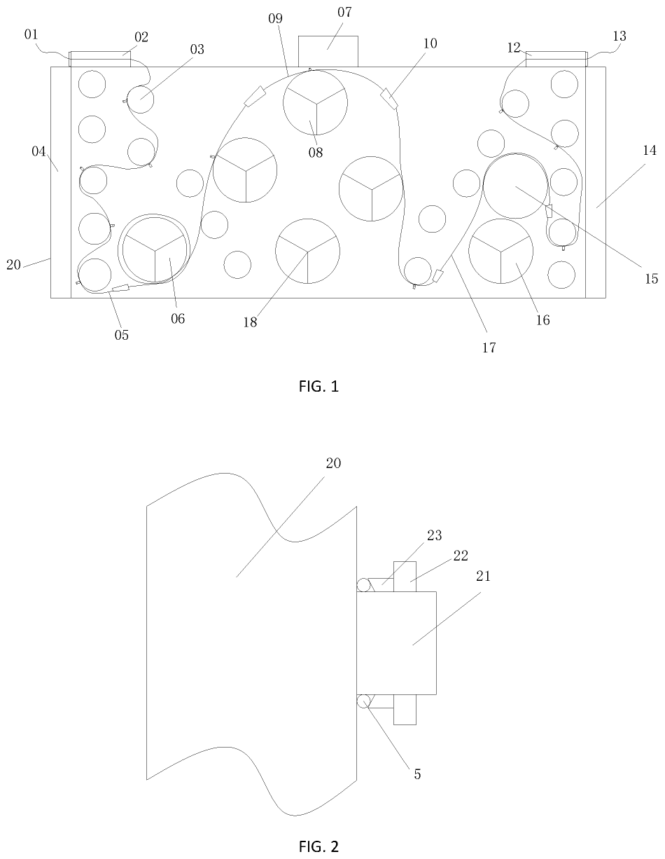

As shown in FIG. 1 and FIG. 2, a flood forecasting system driven by multi-source fusion precipitation information and real-time perception information of the present invention comprises a flood multi-information embedding platform 20, wherein the flood multi-information embedding platform 20 is fixed in a river channel via a fixing device, the flood multi-information embedding platform 20 is provided with 6 large-flow through holes and 18 small-flow through holes which are symmetrically distributed left and right, a large sleeve 21 is mounted on the large-flow through hole, a small sleeve is mounted on the small-flow through hole, a rotatable rotation blade 18 is fixedly mounted in the large sleeve 21, the flood multi-information embedding platform 20 is further provided with a blind hole, and a cylinder 15 is mounted in the blind hole; and a left end surface calibration control end 2 and a right end surface calibration control end 12 are respectively mounted on two sides of a top end of the flood multi-information embedding platform 20, a middle portion of a top portion of the flood multi-information embedding platform 20 is provided with a far-end information carrying box 7, and an optical fiber sequentially penetrates through the plurality of large-flow through holes, the plurality of small-flow through holes and the cylinder 15 via the left end surface calibration control end 2, and is led out via the right end surface calibration control end 12.

In the present invention, a plurality of wedge blocks 10 are mounted on the flood multi-information embedding platform 20, the wedge block 10 is provided with a through hole, and the optical fiber penetrates through the through hole. The optical fiber is fixed on the flood multi-information embedding table 20 via the wedge block 10. The wedge block 10 is mounted on the flood multi-information embedding platform 20 via a fastener, and the fastener is usually a screw.

In the present invention, the large sleeve 21 is provided with an external thread, a large elastic block 23 is sleeved on the large sleeve 21, the optical fiber is pressed on the large sleeve 21 via the large elastic block 23, and the large elastic block 23 is fixed on the large sleeve 21 via a nut 22. The small sleeve is provided with an external thread, a small elastic block is sleeved on the small sleeve, the optical fiber is pressed on the small sleeve via the small elastic block, and the small elastic block is fixed on the small sleeve via a nut 22. The optical fiber is fixed on the large sleeve 21 and the small sleeve via the cooperation of the nut 22 and the thread, and the optical fiber vibrates together with the large sleeve 21 and the small sleeve.

In the present invention, the cylinder 15 is provided with an arc-shaped groove, and the optical fiber penetrates through the arc-shaped groove and is fixed in the arc-shaped groove via a pressing block. The pressing block may be designed as an arc-shaped block to be matched with the arc-shaped groove, and the optical fiber is fixed on the cylinder 15 via the cooperation of the arc-shaped block and the arc-shaped groove.

In the present invention, the optical fiber located in the lower-left large-flow through hole of the flood multi-information embedding platform 20 is wound on the large sleeve 21 by 360°. The rotation blades 18 are distributed in lower left, middle and lower right areas of the flood multi-information embedding platform 20, and in the middle portion of the flood multi-information embedding platform 20, at least a part of the rotation blades 18 are distributed in upper, middle and lower portions of the flood multi-information embedding platform 20.

A use method of the flood forecasting system driven by multi-source fusion precipitation information and real-time perception information above comprises the following steps of:
firstly, sequentially arranging and connecting a left end surface outlet optical fiber 1, a left end surface optical fiber 5, a optical fiber connected in the middle 9, a right end surface optical fiber 17 and a right end surface outlet optical fiber 13, wherein the left end surface outlet optical fiber 1 penetrates through two sides of a left end surface calibration control end 2, a joint between the left end surface outlet optical fiber 1 and the left end surface calibration control end 2 is flexibly fixed, a joint between the right end surface outlet optical fiber 13 and a right end surface calibration control end 12 is flexibly fixed, the left end surface optical fiber 5 is arranged along a small-flow through hole 3, circumferentially wound around a lower-left large-flow through hole 6, and then connected to an upper-middle large-flow through hole 8, and then passes through the small-flow through hole 3 to be circumferentially connected to a cylinder 15, a sensing optical fiber is connected to the small-flow through hole 3 through a nut 22, and the sensing optical fiber is connected to the small-flow through hole 3, the lower-left large-flow through hole 6, the upper-middle large-flow through hole 8 and a lower-right large-flow through hole 16 via wedge blocks 10;
secondly, performing initial sensing and calibration on the left end surface outlet optical fiber 1, the left end surface optical fiber 5, the optical fiber connected in the middle 9, the right end surface optical fiber 17 and the right end surface outlet optical fiber 13, performing strain calibration on the distributed sensing optical fiber in the left end surface calibration control end 2, and performing vibration calibration on the point sensing optical fiber in the right end surface calibration control end 12;
thirdly, rotating rotation blades 18 in the lower-left large-flow through hole 6, the upper-middle large-flow through hole 8 and the lower-right large-flow through hole 16 to test that the rotation blades run normally, and testing data information of the sensing optical fiber under rotating and non-rotating states of the rotation blades 18;
fourthly, determining a quantity of flood multi-information embedding platforms 20, effectively connecting a plurality of flood multi-information embedding platforms 20 via a connecting device, wherein the connecting device may be a left closed connecting rod 4 and a right closed connecting rod 14, and the flood multi-information embedding platforms are connected via the left closed connecting rod 4 and the right closed connecting rod 14, and effectively connecting the left end surface outlet optical fiber 1 and the right end surface outlet optical fiber 13 with the right end surface outlet optical fiber 13 and the left end surface outlet optical fiber 1 on other flood multi-information embedding platforms 20; and
fifthly, arranging the plurality of flood multi-information embedding platforms 20 in a flood area to be tested for real-time sensing, receiving information of atmospheric movement and precipitation in the area collected from satellites and the ground by a far-end information carrying box 7, and fusing, transmitting and forecasting information of the sensing fiber by the far-end information carrying box 7.

Those described above are merely the preferred embodiments of the present invention, and it should be pointed out that those of ordinary skills in the art may further make improvements and decorations without departing from the principle of the present invention, and these improvements and decorations should also be regarded as falling within the scope of protection of the present invention.

What is claimed is:

1. A flood forecasting system driven by multi-source fusion precipitation information and real-time perception information, comprising a flood multi-information embedding platform, wherein the flood multi-information embedding platform is fixed in a river channel via a fixing device, the flood multi-information embedding platform is provided with a plurality of large-flow through holes and a plurality of small-flow through holes which are symmetrically distributed left and right, a plurality of wedge blocks are mounted on the flood multi-information embedding platform, a large sleeve is mounted on the large-flow through hole, a small sleeve is mounted on the small-flow through hole, a rotatable rotation blade is fixedly mounted in the large sleeve, the flood multi-information embedding platform is further provided with a blind hole, and a cylinder is mounted in the blind hole; a left end surface calibration control end and a right end surface calibration control end are respectively mounted on two sides of a top end of the flood multi-information embedding platform, a middle portion of a top portion of the flood multi-information embedding platform is provided with a far-end information carrying box, and an optical fiber sequentially penetrates through the plurality of large-flow through holes, the plurality of small-flow through holes and the cylinder via the left end surface calibration control end, and is led out via the right end surface calibration control end; and a distributed sensing optical fiber without external interference is arranged in the left end surface calibration control end, a point sensing optical fiber without external interference is arranged in the right end surface calibration control end, a left end surface outlet optical fiber penetrates through two sides of the left end surface calibration control end, a joint between the left end surface outlet optical fiber and the left end surface calibration control end is flexibly fixed, a joint between a right end surface outlet optical fiber and the right end surface calibration control end is flexibly fixed, a left end surface optical fiber is arranged along the small-flow through hole, the left end surface optical fiber is wound around a lower-left large-flow through hole by 360°, an optical fiber located in the middle portion of the flood multi-information embedding platform is tightly attached to an upper-middle large-flow through hole in the middle portion to be fixed and calibrated via the wedge blocks on two sides, and a right end surface optical fiber is tightly attached to the cylinder to be wound and fixed.

2. The flood forecasting system driven by multi-source fusion precipitation information and real-time perception information according to claim 1, wherein the wedge block is provided with a through hole, and the optical fiber penetrates via the through hole.

3. The flood forecasting system driven by multi-source fusion precipitation information and real-time perception information according to claim 1, wherein the wedge block is mounted on the flood multi-information embedding platform via a fastener.

4. The flood forecasting system driven by multi-source fusion precipitation information and real-time perception information according to claim 1, wherein the large sleeve is provided with an external thread, a large elastic block is sleeved on the large sleeve, the optical fiber is pressed on the large sleeve via the large elastic block, and the large elastic block is fixed on the large sleeve via a nut.

5. The flood forecasting system driven by multi-source fusion precipitation information and real-time perception information according to claim 1, wherein the small sleeve is provided with an external thread, a small elastic block is sleeved on the small sleeve, the optical fiber is pressed on the small sleeve via the small elastic block, and the small elastic block is fixed on the small sleeve via a nut.

6. The flood forecasting system driven by multi-source fusion precipitation information and real-time perception information according to claim 1, wherein the cylinder is provided with an arc-shaped groove, and the optical fiber penetrates through the arc-shaped groove and is fixed in the arc-shaped groove via a pressing block.

7. The flood forecasting system driven by multi-source fusion precipitation information and real-time perception information according to claim 1, wherein the optical fiber located in the lower-left large-flow through hole of the flood multi-information embedding platform is wound on the large sleeve by 360°.

8. The flood forecasting system driven by multi-source fusion precipitation information and real-time perception information according to claim 1, wherein in a middle area of the flood multi-information embedding platform, at least a part of the rotation blades are distributed in upper, middle and lower portions of the middle area of the flood multi-information embedding platform.

9. The flood forecasting system driven by multi-source fusion precipitation information and real-time perception information according to claim 1, wherein inner walls of the large sleeve and the small sleeve are both polished.

10. A process for utilizing the flood forecasting system driven by multi-source fusion precipitation information and real-time perception information according to claim 1, comprising the following steps of:
firstly, sequentially arranging optical fibers, wherein left end surface outlet optical fiber penetrates through two sides of a left end surface calibration control end, a joint between the left end surface outlet optical fiber and the left end surface calibration control end is flexibly fixed, a joint between a right end surface outlet optical fiber and a right end surface calibration control end is flexibly fixed, the left end surface optical fiber is arranged along a small-flow through hole, circumferentially wound around a lower-left large-flow through hole, and then connected to an upper-middle large-flow through hole, and then passes through the small-flow through hole to be circumferentially connected to a cylinder, a sensing optical fiber is connected to the small-flow through hole via a nut, and the sensing optical fiber is connected to the small-flow through hole, a lower-left large-flow through hole, an upper-middle large-flow through hole and a lower-right large-flow through hole via wedge blocks;
secondly, performing initial sensing and calibration on the left end surface outlet optical fiber, a left end surface optical fiber, an optical fiber located in the middle portion of a flood multi-information embedding platform, a right end surface optical fiber and a right end surface outlet optical fiber, performing strain calibration on the distributed sensing optical fiber in the left end surface calibration control end, and performing vibration calibration on the point sensing optical fiber in the right end surface calibration control end;
thirdly, rotating rotation blades in the lower-left large-flow through hole, the upper-middle large-flow through hole and the lower-right large-flow through hole to test that the rotation blades run normally, and testing data information of the sensing optical fiber under rotating and non-rotating states of the rotation blades;
fourthly, determining a quantity of flood multi-information embedding platforms, effectively connecting a plurality of flood multi-information embedding platforms via a connecting device, and effectively connecting the left end surface outlet optical fiber and a right end surface outlet optical fiber with the right end surface outlet optical fiber and the left end surface outlet optical fiber on other flood multi-information embedding platforms; and
fifthly, arranging the plurality of flood multi-information embedding platforms in a flood area to be tested for real-time sensing, receiving information of atmospheric movement and precipitation in the area collected from satellites and ground by a far-end information carrying box, and fusing, transmitting and forecasting information of the sensing fiber by the far-end information carrying box.
